(19) United States
(12) Patent Application Publication
(10) Pub. No.: US 2016/0180396 A1
(43) Pub. Date: Jun. 23, 2016

(54) Mobile Promotion System, Method and Computer Program Product

(71) Applicant: Sahara Management LLC, Washington, DC (US)

(72) Inventor: John A. DEVOLITES, Oakton, VA (US)

(73) Assignee: Sahara Management LLC, Washington, DC (US)

(21) Appl. No.: 14/574,419

(22) Filed: Dec. 18, 2014

(51) Int. Cl. G06Q 30/02; H04W 4/02

(52) U.S. Cl. CPC G06Q 30/0267; G06Q 30/0258; H04W 4/021

(57) ABSTRACT

A system and method for registration and delivery of mobile promotion such as advertising and/or publicity is set forth herein. Accordingly, various example embodiments of the present disclosure are directed to a system, method and/or a computer program product including a computer-implemented method of registering a user with a mobile promotion service provider system can include: receiving, by at least one computer processor, a selection of a registration request for at least one brand at a mobile device; transmitting, by the at least one computer processor, the registration request to a server; and receiving, by the at least one computer processor, from the server an updated configuration file including confirmation of the registration request, at the mobile device.

### CROSS REFERENCE TO RELATED APPLICATIONS

The present disclosure is a U.S. NonProvisional patent application, presently claiming no priority of any related application.

### BACKGROUND

1. Field of the Disclosure

The present disclosure relates generally to promotional systems, and more particularly to mobile based promotional systems.

2. Related Art

Exemplary promotional systems such as advertising and publicity exist such as, e.g., but not limited to, commercial advertising, offers, coupons, etc. Brand managers are responsible for promoting their brands. In many businesses, whole departments are focused on marketing and sales.

Coupons, offers, and deals have long been useful promotional marketing and advertising tools. Historically, paper or print coupons (e.g., newspaper inserts, print-at-home, shelf-dispenser, etc.) have been distributed directly to potential consumers through direct mail, newspapers, flyers, or magazines. The advantage of paper coupons is that usage can be limited to a single usage by the customer in a particular geography. Redemption of print coupons is at point of sale.

In the electronic age, electronic coupons (e-coupons) distributed via email or posted on websites have become more common. E-coupons or digital coupons (e.g., mobile coupons that are displayed on a mobile device or sent via SMS with key code), the redemption process still takes place at the merchant point-of-sale. However, the actual redemption can be acknowledged in some cases between the manufacturer (or issuer of the coupon) and the consumer. The merchant however has no transparent way to capture a coupon redemption and provide reporting back to the brand owner, manufacturer, and/or issuer. This can make it difficult for manufacturers to distribute coupons or offers across multiple merchant chains without first having to setup each merchant with a proprietary redemption platform. Also, conventional electronic coupons have various disadvantages including that it can be difficult, if not impossible, to control repeated usage by customers, particularly in emailed/printed coupons. Emailed coupons can be easily replicated by reprinting despite efforts to limit printing. Also, coupon sharing sites capture website coupons and can make coupons available for repeated usage, potentially leading to fraudulent redemptions at merchants, if transfers or replication of offers are unauthorized, and lead to refusal to reimburse merchants, by manufacturers.

Several businesses provide electronic offers distributed via smartphone or mobile phones, including Facebook.com, Foursquare.com, Getmealticket.com, Groupon.com, LivingSocial.com, and Valpak.com, among others. Other companies such as restaurant chains email monthly coupons to their past customers using so-called loyalty programs.

Conventional promotional systems have various shortcomings. Conventional coupons for example are difficult to track. Further, conventional advertising systems can be largely ignored by targets of promotions. Current promotion management methods can be captured by spamfilters and other security filters such as fire walls, etc. Conventional promotion management methods are prone to overuse by consumers. Brand managers want to know who their trusted customers are, and to obtain greater wallet share of those loyal customers. Further, conventional promotion management systems lack brand owner control and management tools.

Generally, consumer customers have certain brand loyalty, but also want to know about the latest offers from their favorite brands. Consumers also lack the ability to manage expiration of offerings. Consumers need improved methods of delivering and managing coupons that overcome shortcomings of conventional solutions.

What is needed then are systems and methods that overcome shortcomings of conventional promotional systems.

### SUMMARY

The disclosure sets forth systems, methods and computer program products relating to registration and delivery of mobile-based promotion such as advertising and/or publicity, in illustrative embodiments.

Accordingly, various example embodiments of the present disclosure are directed to a system, method and/or a computer program product including a computer-implemented method of registering a user with a mobile promotion service provider system can include: receiving, by at least one computer processor, a selection of a registration request for at least one brand at a mobile device; transmitting, by the at least one computer processor, the registration request to a server; and receiving, by the at least one computer processor, from the server an updated configuration file including confirmation of the registration request, at the mobile device.

The computer implemented method can further include, in illustrative embodiments receiving, by the at least one computer processor, at the mobile device, from the server, at least one offer from at least one brand server; and displaying, by the at least one computer processor, at the mobile device, the at least one offer.

The computer implemented method can further include, in illustrative embodiments receiving, by the at least one computer processor, a selection of one of the at least one offers; displaying, by the at least one computer processor, an offer activation button on the mobile device; receiving, by the at least one computer processor, a selection of the offer activation button on the mobile device; and activating, by the at least one computer processor, the offer and displaying a scannable code for presentment to a merchant at redemption.

The computer implemented method can further include, in illustrative embodiments, at least one of: notifying, by the at least one computer processor, an associated brand server of the offer activation; or notifying, by the at least one computer processor, the merchant of the offer activation.

The computer implemented method where, in illustrative embodiments the activating can include: momentarily switching on, by the at least one computer processor, geo-location sensing to capture: a location of the mobile device; turning off geo-location sensing, by the at least one computer processor, after the capture; transmitting, by the at least one computer processor, to the server an offer activation request can include: the location; a time; a date; a device ID; and a phone number; receiving, by the at least one computer processor, a validation of the offer activation request from the server; and displaying, by the at least one computer processor, an offer code for redemption on the mobile device.

The computer implemented method can further include, in illustrative embodiments performing, by the at least one computer processor, at the server realtime analytics of activations of offerings; and transmitting, by the at least one computer processor, the analytics to a brand manager.

The computer implemented method can further include, in illustrative embodiments initiating a countdown time limit, by the at least one computer processor, until the offer expires.

The computer implemented method can further include, in illustrative embodiments

cancelling, by the at least one computer processor, the offer on the mobile device upon expiration of the countdown time limit.

The computer implemented method can further include, in illustrative embodiments can include receiving, by the at least one computer processor, a selection at the mobile device of a deregistration request; and transmitting an alert to a Brand manager noting the deregistration to facilitate inviting reregistration.

The computer implemented method where, in illustrative embodiments can include the receiving the selection of the registration request can include: receiving, collecting and transmitting to the server data can include at least one of: at least one brand selected; at least one brand user identifier (ID); at least one brand password; a device identifier (ID); a device type; username; a date registered; a location; or a WI-FI SPID.

The computer implemented method can further include, in illustrative embodiments receiving, collecting and storing data on the mobile device can include: at least one brand; at least one offer identifier (ID); an offer description; an expiration date; a value; a username; a send date; or a predicted location.

The computer implemented method can further include, in illustrative embodiments receiving, collecting, and storing, by the at least one computer processor, at the server at least one of: a brand; an offer identifier (ID); an offer description; an expiration date; a send date; a value; a device identifier (ID); a username; or a predicted location.

The computer implemented method can further include, in illustrative embodiments receiving, collecting, and storing, by the at least one computer processor, at the server at least one of: a brand; an offer identifier (ID); a device identifier (ID); a device type; username; a date; a location; or a WI-FI SPID.

The computer implemented method can further include, in illustrative embodiments synchronizing, by the at least one computer processor, offer data with the server can include at least one of: updating version of application program; adding at least one new offer; deleting at least one old offer; or updating at least one message.

The computer implemented method can further include, in illustrative embodiments indicating relative expiration dates of a plurality of offers can include at least one of: indicating with a color whether an offer will expire soon; indicating with a color whether an offer is new; indicating with a color whether an offer is expired; highlighting whether an offer will expire soon; highlighting whether an offer is new; or highlighting whether an offer is expired.

Another illustrative embodiment can include a system of providing promotions can include: at least one computer processing unit; network interface communicatively coupled to the at least one computer processing unit; a memory communicatively coupled to the at least one computer processing unit, the memory containing instructions that when executed by the at least one computer processing unit configure the system to: receive a selection of a registration request for at least one brand at a mobile device; transmit the registration request to a server; receive from the server an updated configuration file including confirmation of the registration request, at the mobile device.

Another illustrative embodiment can include a computer program product embodied on a computer accessible medium, the computer program product can include program logic, which when executed on at least one computer processor provides a method of providing a promotion can include: receiving, by at least one computer processor, a selection of a registration request for at least one brand at a mobile device; transmitting, by the at least one computer processor, the registration request to a server; and receiving, by the at least one computer processor, from the server an updated configuration file including confirmation of said registration request, at the mobile device.

### BRIEF DESCRIPTION OF THE DRAWINGS

The subject matter herein is particularly pointed out and is distinctly claimed in the claims at the conclusion of the specification. The foregoing and other objects, features and advantages will be apparent from the following detailed description taken in conjunction with the accompanying drawings.

The accompanying drawings, which are included to provide a further understanding and are incorporated herein and constitute a part of this specification, illustrate exemplary, illustrative and nonlimiting embodiments and together with their description serve to explain the principles disclosed herein. In the drawings, like reference numbers may indicate substantially similar, equivalent, or exemplary elements, and the left most digit(s) in the corresponding reference number can indicate the drawing in which an element first appears.

FIG. 1 depicts a schematic representation of an illustrative embodiment of an example marketing and promotion system illustrating an example registration/deregistration process, according to an example embodiment;

FIG. 2 depicts a schematic representation of an illustrative embodiment of the example marketing and promotion system illustrating an example sending offer, such as, e.g., sending an illustrative electronic coupon process, according to an example embodiment;

FIG. 3 depicts a schematic representation of an illustrative embodiment of the example marketing and promotion system illustrating an example offer activation process, such as, e.g., activation of an illustrative coupon process, according to an example embodiment;

FIG. 4 depicts a schematic representation of an illustrative embodiment of the example marketing and promotion system illustrating an example synchronization process, such as, e.g., but not limited to, an electronic coupon synchronization process, according to an example embodiment;

FIG. 5 depicts an exemplary screenshot of an illustrative embodiment of a smartphone application implementing an example home screen of an example marketing and promotion system, according to an example embodiment;

FIG. 6 depicts an exemplary illustration of example screenshots of illustrative embodiments of the smartphone application implementing example brand activation, home screen, coupon selection, map/GPS launch, and coupon activation screens interfacing to an example mobile advertising device (MAD) server of the example marketing and promotion system, according to an example embodiment;

FIG. 7 depicts an exemplary illustration of an example of an example screenshot including illustrative embodiments of graphical user interface example highlighting, including, e.g., but not limited to, color coding illustrating example new and/or soon to expire offers, in an example smartphone application embodiment of the example marketing and promotion system, according to an example embodiment;

FIG. 8 depicts an illustrative embodiment of an electronic device as can be used as an example smartphone communications and/or computing device platform, an exemplary server device, and/or example wireless data network service provider devices, according to various example embodiments.

### DETAILED DESCRIPTION OF VARIOUS EXEMPLARY EMBODIMENTS

It is important to note that the embodiments disclosed are only examples of the many advantageous uses of the innovative teachings herein. In general, statements made in the specification of the present application do not necessarily limit any of the various claims. Moreover, some statements may apply to some inventive features but not to others. In general, unless otherwise indicated, singular elements may be in plural and vice versa with no loss of generality. In the drawings, like reference numerals may refer to like parts through several views.

Reference will now be made in detail to various exemplary embodiments, examples of which are illustrated in the accompanying drawings. While specific exemplary embodiments are discussed, it should be understood that this is done for illustration purposes only. A person skilled in the relevant art will recognize that other components and configurations may be used without parting from the spirit and scope of the disclosure.

### Why Conventional Mobile Advertising Fails to Meet Customer and Brand Management Needs

### Mobile Screens are Too Small to Deliver Effective Advertising

Even with larger mobile phones, screen real estate is still too small to deliver normal advertising. The key reason conventional mobile advertising fails is a desire to attempt to replicate what a consumer sees on television, or with an Internet Browser on a wired computing device. The viewable mobile screen area on a mobile device is just not large enough, and limited wireless bandwidth together delivery of an effective medium to deliver an effective visual advertising platform.

### Conventional Email Offers are Perceived as Spam

Sending solicited or unsolicited emails to a mobile user is largely perceived by mobile consumers seen as the brand sending spam. The perception that emailed offers is SPAM can diminish or hurt the brand.

### Location, Location, Location.

Without active location data, conventional mobile advertising can be delivered to a consumer's service address that may not be in the same state as the mobile device.

### Who am I?

Without knowing who is using a conventional mobile device, mobile ads dollars are ineffectively spent, i.e., wasted.

### Overview of an Example Embodiment

An exemplary embodiment of a system, method and/or computer program product, for registering a user mobile device with one or more brands, can include in one embodiment, receiving a registration request at the mobile device, and sending a registration request to a server.

In an illustrated embodiment, upon the user mobile device registering with one or more brands, then the server can begin to transmit offers to the mobile device.

In an illustrated embodiment, after one or more offers have been transmitted from the server to the mobile device, then the user can select one of the offers. The offer can be activated at point of sale, and upon offer activation various entities can be notified of the activation.

In an illustrated embodiment, the activated offer can be used by presenting the activated offer to the point of sale person and then scanning the barcode.

In an illustrated embodiment, if the mobile user decides to deregister the mobile device, then the Brand manager can be alerted, and steps to encourage re-registration can be taken.

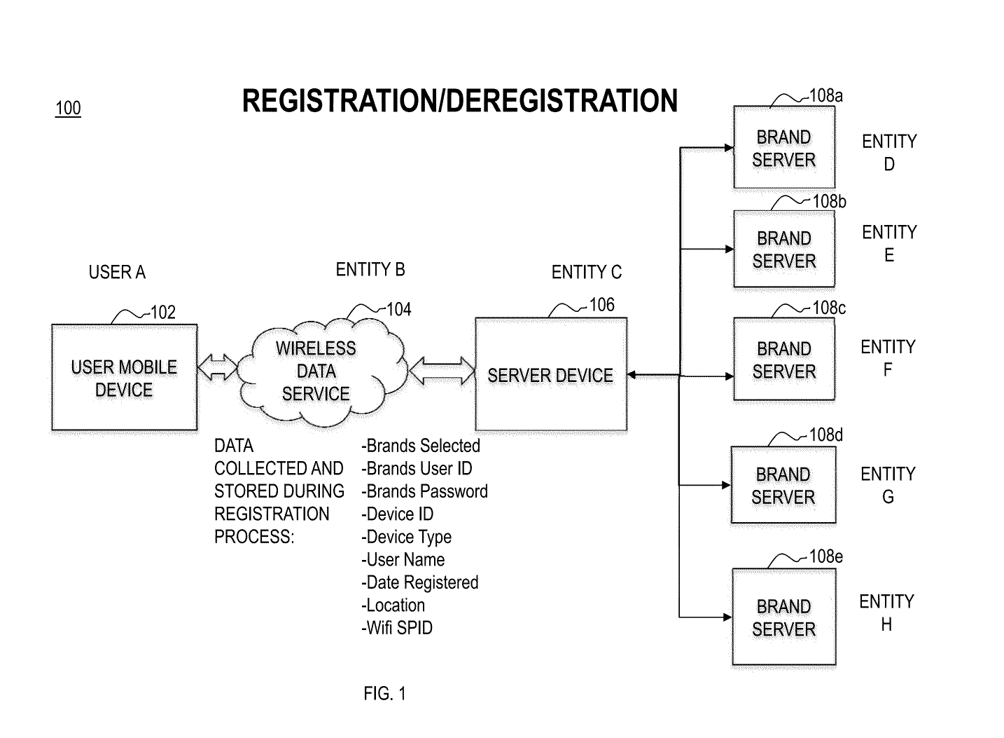

FIG. 1 depicts a schematic representation, of an illustrative embodiment of an example marketing and promotion system illustrating an example registration/deregistration process 100, according to an example embodiment.

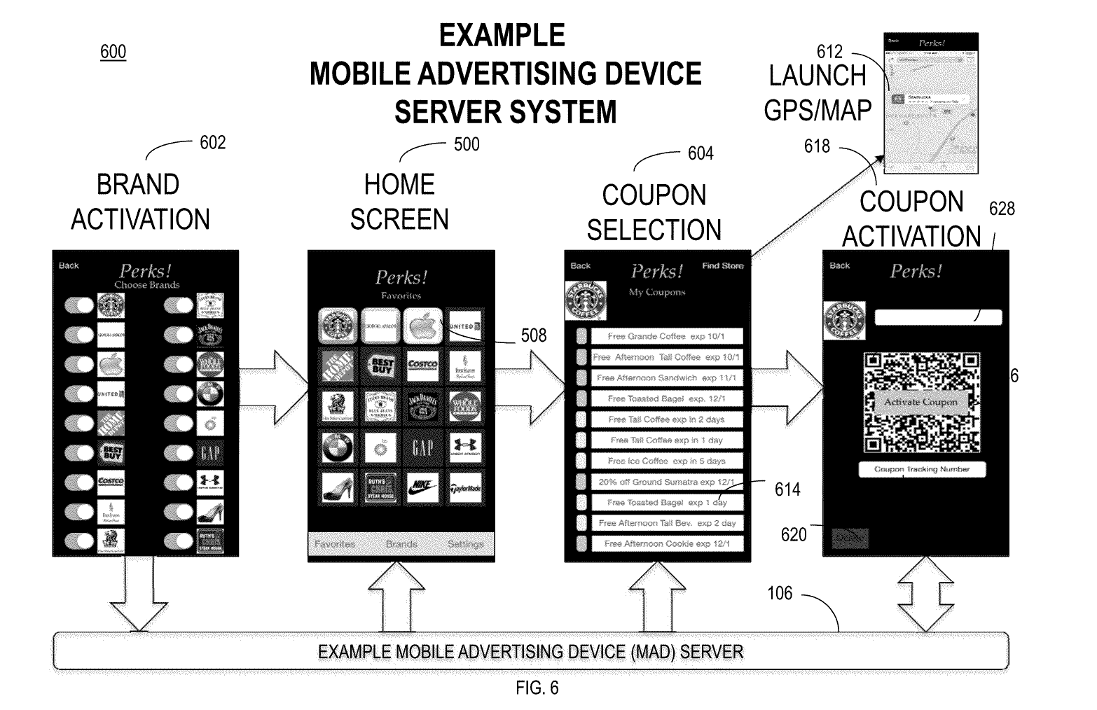

FIG. 1 includes in the example marketing and promotion system 100, in the illustrated embodiment, a user mobile device 102 representing an example mobile device which can connect or couple, via an example wireless data service 104, in an illustrative embodiment. The wireless data service 104 can be coupled to one or more server devices 106, wirelessly or wired via a data network. As illustrated, user A can be a consumer in an illustrative embodiment. Wireless data service 104 can be associated with a separate entity B as illustrated. Server device 106 as shown in the illustrated embodiment can be a separate entity C from entity B. In other exemplary embodiments, entity C and entity B could be the same entity. When the user A using the user mobile device 102 selects any of a group of brands D-H, that the user wishes to receive offers/coupons from at user mobile device 102, the illustrated embodiment of an registration process can be initiated with the server device 106, which can be a wireless or wired server 106, in one illustrative embodiment. Server 106 can collect information specified by the brands D-H (represented by entities D-H on the right side of FIG. 1), and can update example brand servers 108a-108e, respectively, in the illustrative embodiment. Brand servers 108a-108e can each be associated with a separate brand D-H, in one illustrative embodiment. In another embodiment, several brands may be associated with a given brand server 108a-108e. Once registration is complete, server 106 can update a configuration file on the user mobile device 102 of user A, in an illustrative embodiment, to allow customized access by user A to various example offerings from registered brands D-H. See the description of FIG. 6 below for further details of an example mobile advertising device (MAD) server system 600, according to one illustrative embodiment.

According to one exemplary embodiment, various data can be captured, collected, aggregated and stored from user A by the system an can be stored at either the wireless data service 104, and/or at the server device 106, according to example embodiments. Example, but nonlimiting data, which can collected and stored on server 106 during the example registration process 100 of FIG. 1 can include, for a given user A, but is not limited to, in one embodiment:
Brands Selected by the user A;
Brands User ID of the user A;
Brands Password of the user A;
Device ID of the user A;
Device Type of the user A;
User Name of the user A;
Date Registered of the user A;
Location of the user A; and/or
WIFI service profile identifier (SPID) of the user A.

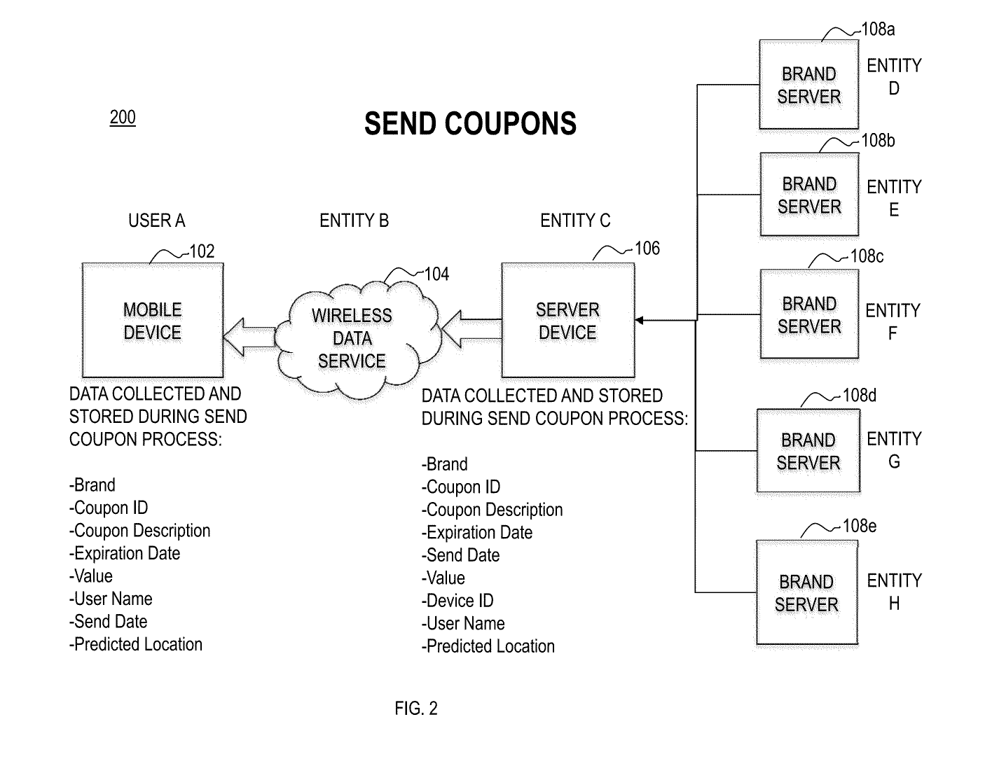

FIG. 2 depicts a schematic representation of an illustrative embodiment of the example marketing and promotion system illustrating an example sending offer process 200, such as, e.g., sending an illustrative electronic coupon process 200, according to an example embodiment.

FIG. 2 illustrates in the example electronic coupon process 200, example brands D-H can send exemplary coupons/offers to server 106 for processing and/or further management and/or transmission to mobile device 106 via wireless data network service 104, in an illustrative embodiment. Server 106 can distribute coupons/offers to mobile device 102 of user A based on the user name, brand registrations and a known location of the user A, in an illustrative embodiment.

Example data can be collected and/or stored, in one embodiment on the server device 106 and/or on a device of the wireless data service 104, in exemplary embodiments. In the illustrated embodiment, data collected and/or stored on server 106 (or on a wireless data service computing device 104) during the example send coupon process 200 can include, but is not limited to:
Brand associated with the coupon;
Coupon ID associated with the coupon;
Coupon Description associated with the coupon;
Expiration Date associated with the coupon;
Send Date associated with the coupon;
Value associated with the coupon;
Device ID associated with the coupon;
User Name associated with the coupon; and/or
Predicted Location associated with the coupon.

Example data can be collected and/or stored, in one embodiment on the mobile device 102 of user A. In an illustrated embodiment, data can be collected, and/or stored on, and/or forwarded from, mobile device 102 during an example send coupon process 200 including, but not limited to, in one embodiment:
Brand associated with the coupon;
Coupon ID associated with the coupon;
Coupon Description associated with the coupon;
Expiration Date associated with the coupon;
Value associated with the coupon;
User Name associated with the coupon;
Send Date associated with the coupon; and/or
Predicted Location associated with the coupon.

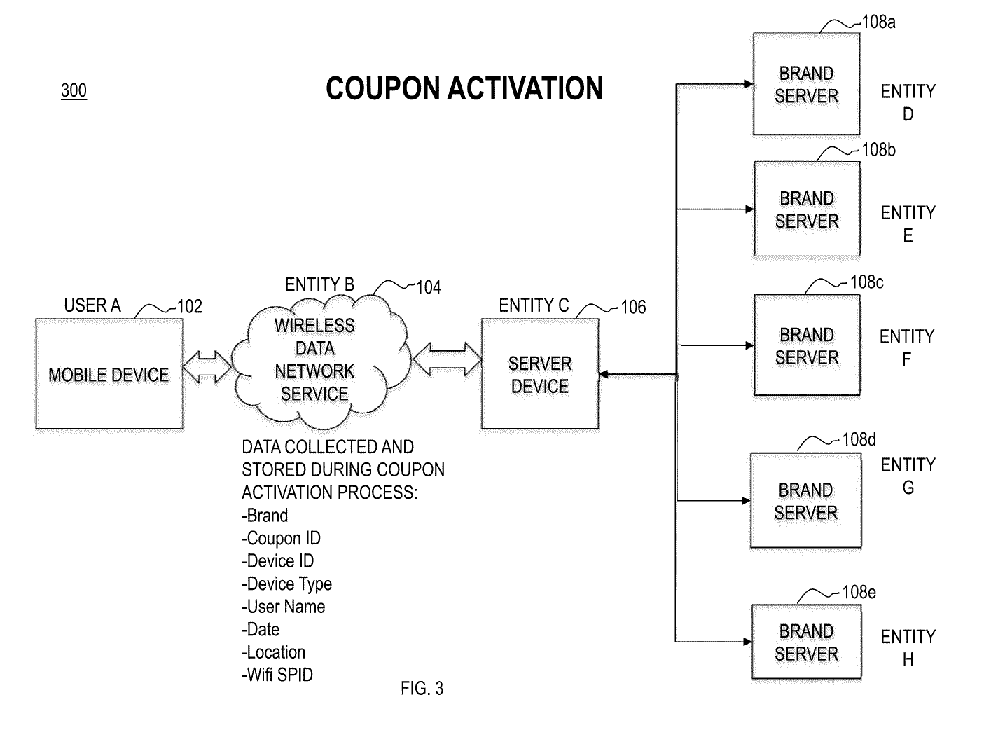

FIG. 3 depicts a schematic representation of an illustrative embodiment of the example marketing and promotion system illustrating an example offer activation process, such as, e.g., activation of an illustrative coupon process 300, according to an example embodiment.

FIG. 3 illustrates the example coupon process 300 including, in one embodiment, mobile device 102 representing a mobile device of user A, which in an example embodiment can connect, or couple to a wireless data service 104. An example wireless data service 104 can include, in one embodiment, one or more wireless access devices of a mobile service provider such as, e.g., but not limited to, Verizon Wireless, AT&T Mobile, T-Mobile, etc., and/or one or more application server(s), web server(s), and/or router(s) of an example data network, and/or the network can provide wireless and/or wired access to other computing and/or communications devices via one or more network communications not shown, but as understood to those skilled in the relevant art. When the user A of the mobile device 102 selects a coupon to use from the example device (as discussed further below with reference to FIG. 6), mobile device 102 can connect and/or couple to server 106 to record that a coupon has been activated, in an illustrative embodiment. In one example embodiment, once activated, the coupon can become valid for use for an example period of time. The coupon is activated on mobile device 102 of user A and a predetermined countdown of the example period of time, on the mobile device 102 can be initiated, or can commence, for cancellation, in an illustrative embodiment. Server 106 can connect and/or couple to the brand servers 108A-108E of respective brands D-H, which issued the coupon and can transmit a notification that the coupon has been activated for use, in an illustrative embodiment. Thus, the brand D-H can be optionally be notified in near realtime of the impending use of the electronic offer, and can run further processing in one embodiment, to ensure use is authorized, and/or can perform further processing, and/or provide further feedback to the consumer regarding the anticipated sale, and/or the merchant of an impending sale, in one embodiment. Thus coupon activation, in an exemplary embodiment can occur only if authorized, and the coupon can be granted a token with a limited time period to avoid unauthorized use of an electronic coupon, in one illustrative embodiment.

In one illustrated embodiment, the wireless data network service device 104 (and/or the server device 106) can collect and/or store various data. In an example embodiment, the wireless data network service 104 can perform processing including, e.g., but not limited to, collecting data, and/or storing, and/or forwarding data, on wireless data network service 104 and/or on server 106 during an example coupon activation process, with data including, e.g., but not limited to:
Brand associated with the activated coupon of user A;
Coupon ID associated with the activated coupon of user A;
Device ID associated with the activated coupon of user A;
Device Type associated with the activated coupon and user A;
User Name associated with the activated coupon and user A;
Date associated with the activated coupon activation of user A;
Location associated with the activated coupon activation; and/or
Wifi SPID associated with the activated coupon and user A.

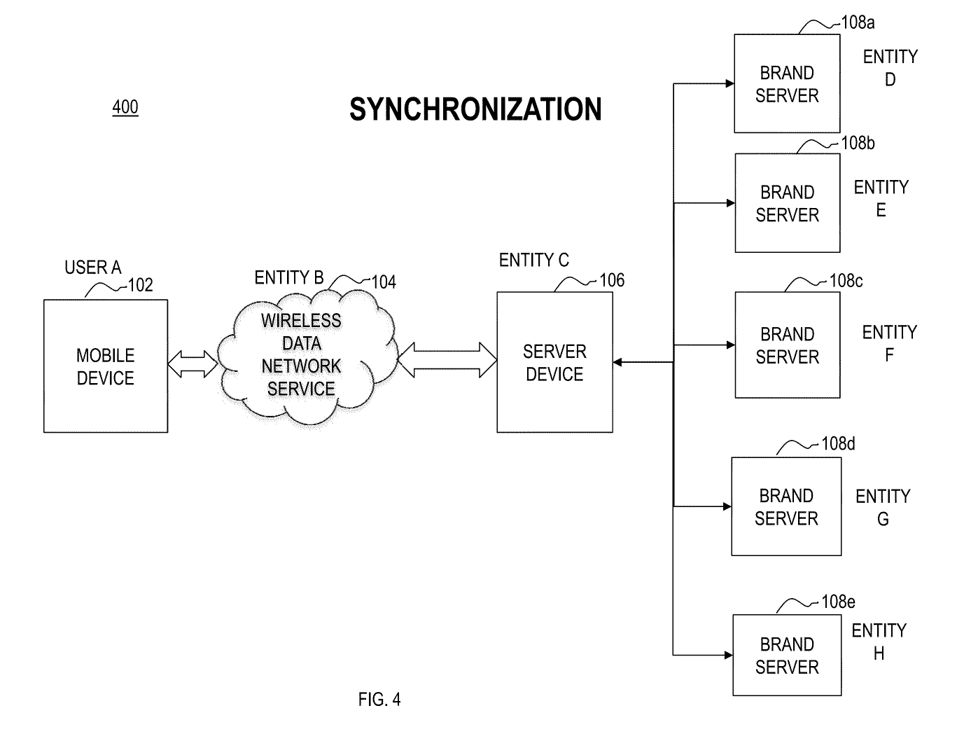

FIG. 4 depicts a schematic representation of an illustrative embodiment of the example marketing and promotion system illustrating an example synchronization process, such as, e.g., but not limited to, an electronic coupon synchronization process 400, according to an example embodiment.

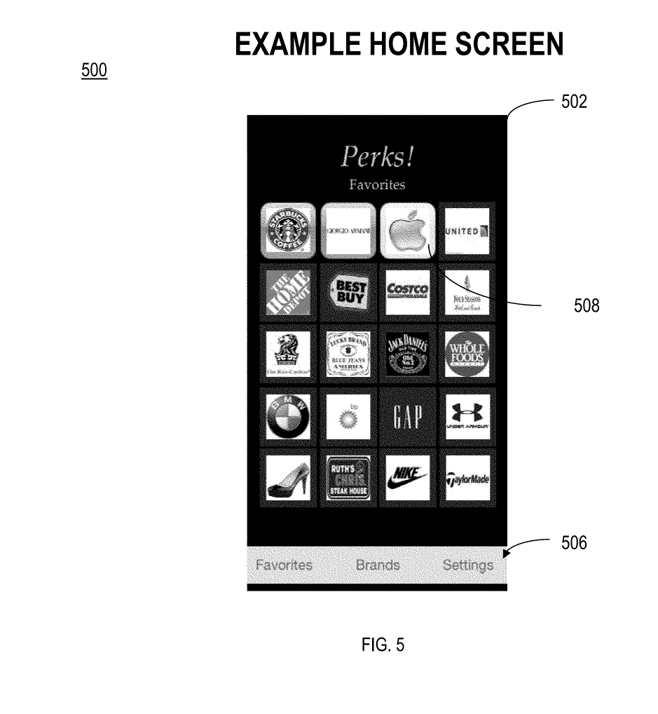

FIG. 4 shows in the illustrated embodiment, an example of the electronic coupon synchronization process 400, including when the user A starts the application program (a mobile smartphone app in one exemplary embodiment, which can be running on an example iOS and/or Android, etc., operating system in example embodiments) on the mobile device 102 of user A, the application can initiate and process a series of processes synchronizing with the server 106 via the wireless (and/or wired) data network service 104, in an illustrative embodiment. The application program (such as, e.g., but not limited to, the app as described further below with reference to FIGS. 5-7), in one illustrated embodiment, can, e.g., but not limited to, verify integrity of the application data stored on mobile device 102 of user A, can update application version, can add new offers, delete old offers, delete expired offers, and/or update messages (such as, e.g., but not limited to, brand information, advertising, special offers, information, posts, messages, etc.), in an illustrative embodiment.

FIG. 5 depicts an exemplary screenshot of an illustrative embodiment of a smartphone application implementing an example home screen shot 500 of an example marketing and promotion system, according to an example embodiment.

FIG. 5 in the illustrated embodiment can include application home screen 502, which can include one or more brand icons 504, 508, with which the example user A has registered. In the example application program screen, can have an example application title, in the illustrated embodiment “Perks” can be the title. In the illustrated embodiment, one or more favorite brands of the user A have been registered as described above with reference to FIG. 1. As illustrated, one or more menu items 506 can be included allowing user A to select additional functionality such as, e.g., but not limited to, selecting additional brands for registration, choosing favorite brands, and or adjusting settings of the program such as, e.g., but not limited to, adjusting features such as, e.g., but not limited to, passwords, synchronization times, categories of offers of interest, deregistration, and/or other brand, and/or other promotion related parameters, etc. In the illustrated embodiment, certain brands can be highlighted, using, e.g., but not limited to, color, and/or blinking, or animation, etc., to indicate via color coding and/or other coding the status of, e.g., but not limited to, arrival of a new offer/coupon, impending expiration of an offer or coupon, etc. For example, in one embodiment, a green indication can indicate a new offer has arrived since the application was last accessed, and/or that an offer is pending and will not expire for at least a certain threshold of time, such as, e.g., but not limited to, 1 week, 30 days, etc. In one embodiment, a yellow indication could highlight to the user A that a coupon is about to expire within a particular threshold such as, e.g., but not limited to, 1 week, 30 days, etc. In one embodiment, the color coding can be set by the application. In another example embodiment, the color coding and thresholds can be user customizable. In another example embodiment, a red highlight can indicate that a coupon is set to expire within the next week, and/or that the coupon has already expired. In another example embodiment, a blinking or greyed out ghost icon can indicate that a coupon has expired. In another example embodiment, a blue background can indicate, e.g., but not limited to that new content and/or offers has arrived. In another example embodiment, other highlighting can be used to assist those with color deficiences, including non-color visual features that can be provided such as, e.g., but not limited to, such as, e.g., but not limited to, cross-hatching, underlining, blinking text, arrows, and/or dotted lines, etc. In another exemplary embodiment, indications for the sight impaired can be provided such as, e.g., but not limited to, a verbal indication of the status of a coupon that can be read via screen reading devices, etc.

FIG. 6 depicts an exemplary illustration 600 of example screenshots of illustrative embodiments of the smartphone application implementing example brand activation screen 602, example home screen 500, example coupon selection screen 604, example map/GPS launch screen 612, and example coupon activation screen 628 interfacing to an example mobile advertising device (MAD) server 106 of the example marketing and promotion system 100, according to an example embodiment.

FIG. 6 illustrates in the exemplary illustration 600 various screen shots of an example graphical user interface (GUI) of an exemplary smartphone, and/or mobile phone, and/or computer application, and/or tablet application, and/or Phablet application, etc., application can transmit and/or receive data to and/or from an example mobile advertising device (MAD) server 106, in various embodiments.

As illustrated, brand activation 602 can include a listing of one or more brands (such as, e.g.., but not limited to, brands D-H of FIG. 1) and one or more GUI interface elements that can be used to receive a user selection of a desired brand for registration, according to one embodiment. In the illustrated embodiment, the user A can use GUI element 602, to activate an example animated slider to select to register with a given brand associated with the example “Perks” platform of the example embodiment.

The illustrated embodiment, can provide major brand aggregation management to improve mobile ad visibility, offer consumption, and encourage brand loyalty. In an illustrative embodiment, by using the illustrated offer activation process described in FIG. 6, the redemption and effectiveness of offers can be determined in real time. Merchants can be made aware of coupon activations, and can be alerted to impending purchase activity, in one embodiment.

Upon user selection of at least one brand from brand activation screen 602, and/or thereafter, or before (no order is specifically required and/or implied in some embodiments), a communication can be sent to MAD server 106 as shown to register with the particular brand, in one embodiment. Once the user has registered with a number of brands, then the home screen 500 can be displayed to the user A providing the one or more registered brands along with, according to one embodiment, an exemplary highlight of, e.g., but not limited to, any new, currently pending offers, and/or unactivated coupons, and/or activated coupons, and/or soon to expire offers/coupons, and/or expired offers, etc. During example synchronization, one or more highlights and/or one or more new coupons can be pushed to the mobile device 102 from server 106, via, e.g., but not limited to, one or more data network elements 104 (not shown). In one embodiment as illustrated the server 106 can be coupled directly and/or indirectly to mobile device 102 and thus can transfer data directly and/or indirectly to the mobile device 102 from the server device 106, in an example embodiment. In other embodiments, one or more other intermediate devices (not shown) can transfer data between the devices via, e.g., but not limited to, one or more access point(s), router(s), server(s), client(s), etc. Also, although the use of client server terminology is used within the example embodiments, a peer to peer form of communication is equally possible, as well as any of various other topologies such as, e.g., but not limited to, a cloud-based, application service provider (ASP) and/or software as a service (SAAS) offering, etc.

From selection of a given brand's GUI element 504, 508 on the example home screen 500, the mobile device 102 of user A can have displayed an example coupon selection screen 604, which can include an example listing of any coupons for the selected brand 504, 508 selected on home screen 500. As will be apparent, alternative orders of screen selection are possible within the scope of this disclosure, and illustrated embodiments are provided for clarity, and are nonlimiting. Various example highlighting and/or color coding and/or other indications can be provided and/or displayed for the example brand 606 including one or more offers 614, along with example highlighting, e.g., green for active, yellow for soon to expire, and/or red for recently expired, and/or grayed out, etc., and/or other indications of offer status, offer details, offering name, offering terms and conditions, etc., as can be displayed after receipt from the MAD server 106 as illustrated, in one embodiment.

As illustrated, coupon selection screen 604 can include a GUI element 610, for user A to select to find a store associated with the one or more offerings/coupons listed, in one embodiment. When the system receives a user selection of a find store selection 610, the system can provide an example map 612 with directions and can request a GPS location to provide directions to the location, in one embodiment. The coupons available can include highlighting indicating, e.g., by color or other indication, a relative expiration date as compared to other coupons, such as, e.g., as illustrated, coupons expiring within a given period, such, e.g., but not limited to, within 5 days, a week, 2 weeks, 30 days, etc., can be noted with a yellow indication, and those not set to expire until over 5 days, over one week, over 2 weeks, or over 30 days, etc., can have another indication, such as, e.g., but not limited to, a green indication.

If the user A selects to choose one of the coupons 614 on coupon selection screen 604, then coupon activation screen 618 can appear with an exemplary qr-code 622, and an example coupon activation button 624. When the coupon activation selection is received by the application, then a coupon tracking number 626 can be assigned, and further information, such as, e.g., but not limited to, coupon information 628, which can include a description of the offer, the user, and/or other coupon related data. In an illustrative embodiment, the coupon tracking number and other information about the activated coupon can be transmitted to the MAD server 106 as shown.

Why Perks! works:

“Perks!” according to an illustrative embodiment, takes a different approach to Mobile Advertising than conventional approaches, by creating a Brand Aggregation & App platform that can enable the consumer to select the Brands that the customer wants, from which to actively receive digital offers.

In order to receive the offers, according to an illustrative embodiment, the consumer must explicitly agree to the following:
Identification:

To use the App the consumer must identify oneself to the Brand which includes the consumer's name, email address, mobile phone number and loyalty member ID, which is verified by the Perks! MAD cloud server, according to an illustrative embodiment. The consumer can register for each Brand and that registration data can be sent to the Perks! MAD cloud server and the Brand's registration servers, according to an illustrative embodiment.
Sending Offers:

Once the consumer has properly registered for the Brands of the consumer's choice, offers will be synchronized with the App based on the Brands' individual advertising campaigns, according to an illustrative embodiment.

### Why Perks! Works:

Offer Activation

As each offer is activated for use on the Perks! Mobile App, the offer can be validated with the Perks! MAD cloud server, according to an illustrative embodiment. Geo-Location can be switched on momentarily so that location, time, day, device ID and phone number can be collected by the Perks! MAD cloud server, according to an illustrative embodiment. The offer can be considered redeemed either after 5 minute interval or a time period specified by the Brand, according to an illustrative embodiment. The activated offer can have a illustrative countdown screen so that the consumer can know the offer has been activated, according to an illustrative embodiment. Once the time limit expires, the offer can be cancelled on the mobile device, according to an illustrative embodiment.

Alternatively, Perks! can also be integrated with the Brands store Point of Sale system to manage offer cancellation, according to an illustrative embodiment.
Real Time Analytics:

The Perks! MAD server can be aware of offers that have been sent to Mobile devices and can know when and where the example offers have been activated for use, according to an illustrative embodiment. The knowledge of offers, and activation of the offers can give the Brands a major competitive edge for Advertising and real time management feedback on campaigns, according to an illustrative embodiment.

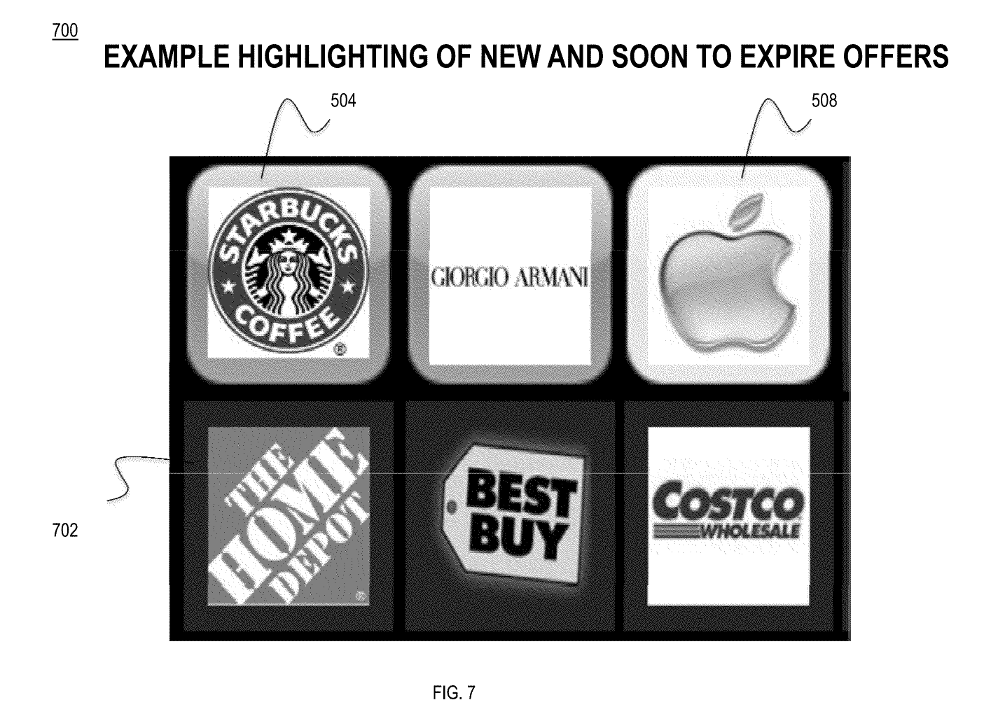

FIG. 7 depicts an exemplary illustration of an example of an example screenshot 700 including illustrative embodiments of a portion of a graphical user interface, including example highlighting, including, e.g., but not limited to, color coding illustrating example new coupons 702, active coupons 504, which are not set to expire within an expiration threshold range, and/or soon to expire offers 508 within an expiration threshold range, in an example smartphone application embodiment of the example marketing and promotion system, according to an example embodiment. Other highlighting, and/or color coding may be used to illustrate existence of coupons, and relative expiration dates of coupons of various devices.

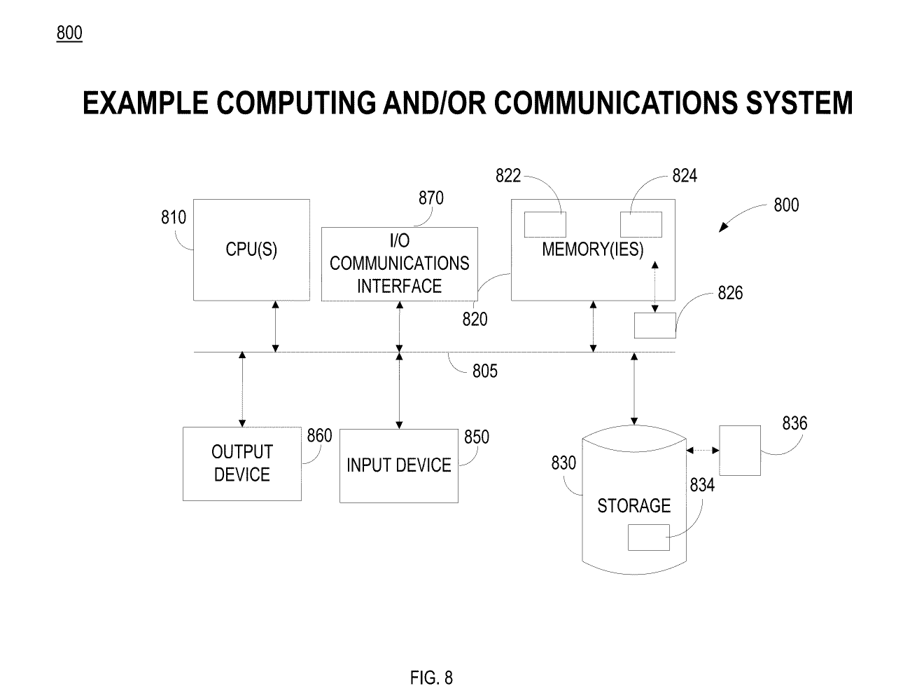

FIG. 8 depicts a schematic illustration of an example communications and/or computing system 800 implemented according to an exemplary embodiment. The system 800 can include at least one processing element 810, for example, a central processing unit (CPU). According to an exemplary embodiment, the CPU is coupled via a bus 805 to a memory 820. The memory 820 includes, in an exemplary embodiment, a memory portion 822 that can contain instructions that when executed by the processing element 810 can perform the methods described in more detail herein. The memory 820 may be further used, according to an exemplary embodiment, as a temporary storage element for the processing element 810, and/or other uses, as the case may be. The memory may comprise, in an exemplary embodiment, volatile memory such as, e.g., but not limited to, random access memory (RAM), and/or non-volatile memory (NVM), such as, e.g., but not limited to, Flash memory, etc. Memory 820 may further include, in an exemplary embodiment, a memory portion 824 containing an application program and/or application data, etc., according to an exemplary embodiment. The processing element 810 may be coupled to an input 850, in one exemplary embodiment. The processing element 810 may be further coupled with a database 830 and/or other storage device 830. Database system and/or storage device 830, in an example embodiment, can be used for the purpose of holding a copy of the method executed in accordance with the disclosed technique. Database 830 may further include, e.g., but may not be limited to, a storage portion 834, which may include and/or contain sub-portions of an application, and/or data referenced by the application, in an exemplary embodiment. In one embodiment, the promotion system can be configured to execute the methods described herein with respect of the remaining figures. The exemplary method, system, and/or computer program products, may be hardwired or, presented as a series of programmable instructions to be executed by the processing element 810.

The principles disclosed herein can be implemented as hardware, firmware, software or any combination thereof. Moreover, the software can be implemented as an application program tangibly embodied on a program storage unit or computer readable medium. The application program may be uploaded to, and/or be executed by, a machine comprising any suitable architecture. The machine may be implemented on a computer platform 800 having hardware such as, e.g., but not limited to, a processing unit (“CPU”) 810, a memory 820, and/or input interfaces 850, output interfaces (not shown), as well as other components not shown for simplicity, but as would be well known to those skilled in the relevant art. The computer platform may also include, in an exemplary embodiment, an operating system and/or microinstruction code. The various processes and/or functions described herein may be either part of the microinstruction code and/or part of the application program, and/or any combination thereof, which may be executed by a CPU 810, whether or not such computer and/or processor is explicitly shown. In addition, various other peripheral units may be connected, and/or coupled, to the computer platform such as, e.g., but not limited to, an additional memory unit 826 and/or removable memory unit 826, an additional data storage unit 836 and/or removable storage unit 836, and a printing unit, and/or display unit, and/or other input 850, output 860, communication 870 and/or networking components 870, etc.

References to “one embodiment,” “an embodiment,” “example embodiment,” “various embodiments,” “exemplary embodiment,” “exemplary embodiments,” etc., may indicate that the embodiment(s) so described may include a particular feature, structure, or characteristic, but not every embodiment necessarily includes the particular feature, structure, or characteristic. Further, repeated use of the phrase “in one embodiment,” or “in an exemplary embodiment,” do not necessarily refer to the same embodiment, although they may.

In the following description and claims, the terms “coupled” and “connected,” along with their derivatives, may be used. It should be understood that these terms are not intended as synonyms for each other. Rather, in particular embodiments, “connected” may be used to indicate that two or more elements are in direct or indirect physical or electrical contact with each other. “Coupled” may mean that two or more elements are in direct physical or electrical contact. However, “coupled” may also mean that two or more elements are not in direct contact with each other, but yet still co-operate or interact with each other.

An algorithm is here, and generally, considered to be a self-consistent sequence of acts or operations leading to a desired result. These include physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these nontransitory signals as bits, values, elements, symbols, characters, terms, numbers or the like. It should be understood, however, that all of these and similar terms are to be associated with the appropriate physical quantities and are merely convenient labels applied to these quantities.

Unless specifically stated otherwise, as apparent from the following discussions, it is appreciated that throughout the specification discussions utilizing terms such as “processing,” “computing,” “calculating,” “determining,” or the like, refer to the action and/or processes of a computer or computing system, or similar electronic computing device, that manipulate and/or transform data represented as physical, such as electronic, quantities within the computing system's registers and/or memories into other data similarly represented as physical quantities within the computing system's memories, registers or other such information storage, transmission or display devices.

In a similar manner, the term “processor” can refer to any device or portion of a device that processes electronic data from registers and/or memory to transform that electronic data into other electronic data that can be stored in registers and/or memory. A “computing platform” can comprise one or more processors. In one embodiment, a processor can include an embedded processor, and/or another subsystem processor, and/or a system on a chip, device.

Embodiments may include apparatuses for performing the operations herein. An apparatus may be specially constructed for the desired purposes, or it may comprise a general purpose and/or special purpose device selectively activated or reconfigured by a program stored in the device.

Computer programs (also called computer control logic), may include computer application programs, and can include object oriented computer programs, and can be stored in memory 820, and/or secondary memory, such as, e.g., storage 820, 822, 824, 826, 830, 834, 836 and/or removable memory and/or storage units 826, 836, also called computer program products. Such computer programs, when executed, may enable the computer system 800 to perform the features as discussed herein. In particular, the computer programs, when executed, may enable the processor 810 to provide various functionality to the system 800 so as perform certain functions, according to an exemplary embodiment. Accordingly, such computer programs may represent controllers of the computer system 800.

In another exemplary embodiment, the methods may be directed to a computer program product comprising a computer readable medium having control logic (computer software) stored therein. The control logic, when executed by the processor 810, may cause the processor 810 to perform features as described herein. In another exemplary embodiment which can be implemented using software, the software can be stored in a computer program product 836, 826, and can be loaded into computer system 800 using, e.g., but not limited to, the storage 830, the removable memory and/or storage device 826, 836, respectively, hard drive and/or communications and/or network interface 870, and/or router, etc. The control logic (software), when executed by the processor 810, can cause the processor 810 to perform the functions as described herein. The computer software can run as a standalone software application program running atop an operating system, or may be integrated into the operating system and/or application program, and/or may be executed as an applet, or networked and/or client-server, and/or browser-based and/or other process as is well known.

In yet another embodiment, implementation may be primarily in hardware using, for example, but not limited to, hardware components such as application specific integrated circuits (ASICs), or one or more state machines, etc. Implementation of the hardware state machine so as to perform the functions described herein will be apparent to persons skilled in the relevant art(s).

In another exemplary embodiment, as noted, implementation can be primarily in firmware.

In yet another exemplary embodiment, implementation can combine any of, e.g., but not limited to, hardware, firmware, and software, etc.

Exemplary embodiments may also be implemented as instructions stored on a machine-readable medium, which may be read and executed by a computing platform to perform the methods described herein. A machine-readable medium may include any mechanism for storing or transmitting information in a form readable by a machine (e.g., a computer). For example, a machine readable medium can include read only memory (ROM); random access memory (RAM); magnetic disk storage media; optical storage media; flash memory devices; electrical, optical, acoustical or other form of nontransitory propagated signals (e.g., carrier waves, infrared signals, digital signals, etc.), memory 820, storage 830, and others.

The exemplary embodiments make reference to wired, and/or wireless networks. Wired networks can include any of a wide variety of well known means for coupling voice and data communications devices together. Similarly, any of various exemplary wireless network technologies may be used to implement the embodiments discussed. Specific details of wireless and/or wired communications networks are well known and are not included, as will be apparent to those of ordinary skill in the relevant art.

All examples and conditional language recited herein are intended for pedagogical purposes to aid the reader in understanding the principles of the invention and the concepts contributed by the inventor to furthering the art, and are to be construed as being without limitation to such specifically recited examples and conditions. Moreover, all statements herein reciting principles, aspects, and embodiments of the invention, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

While various embodiments have been described above, it should be understood that they have been presented by way of example only, and not limitation. Thus, the breadth and scope of the disclosure should not be limited by any of the above-described exemplary embodiments, but should instead be defined only in accordance with the following claims and their equivalents. It will be apparent to those skilled in the art that various modifications and variations can be made without departing from the spirit or scope of the disclosure. Thus, it is intended that the disclosure cover the modifications and variations provided they come within the scope of the appended claims and their equivalents.

What is claimed is:

1. A computer-implemented method of registering a user with a mobile promotion service provider system comprising:
receiving, by at least one computer processor, a selection of a registration request for at least one brand at a mobile device;
transmitting, by the at least one computer processor, said registration request to a server; and
receiving, by the at least one computer processor, from the server an updated configuration file including confirmation of said registration request, at the mobile device.

2. The computer-implemented method of claim 1, further comprising:
receiving, by the at least one computer processor, at the mobile device, from the server, at least one offer from at least one brand server; and
displaying, by the at least one computer processor, at the mobile device, the at least one offer.

3. The computer-implemented method of claim 2, further comprising:
receiving, by the at least one computer processor, a selection of one of said at least one offers;
displaying, by the at least one computer processor, an offer activation button on the mobile device;
receiving, by the at least one computer processor, a selection of said offer activation button on the mobile device; and
activating, by the at least one computer processor, the offer and displaying a scannable code for presentment to a merchant at redemption.

4. The computer-implemented method of claim 3, further comprising at least one of:
notifying, by the at least one computer processor, an associated brand server of the offer activation; or
notifying, by the at least one computer processor, the merchant of the offer activation.

5. The computer-implemented method of claim 3, wherein said activating comprises:
momentarily switching on, by the at least one computer processor, geo-location sensing to capture:
a location of the mobile device;
turning off geo-location sensing, by the at least one computer processor, after the capture;
transmitting, by the at least one computer processor, to the server an offer activation request comprising:
the location;
a time;
a date;
a device ID; and
a phone number;
receiving, by the at least one computer processor, a validation of the offer activation request from the server; and
displaying, by the at least one computer processor, an offer code for redemption on the mobile device.

6. The computer-implemented method of claim 3, further comprising:
performing, by the at least one computer processor, at the server realtime analytics of activations of offerings; and
transmitting, by the at least one computer processor, said analytics to a brand manager.

7. The computer-implemented method of claim 3, further comprising:
initiating a countdown time limit, by the at least one computer processor, until the offer expires.

8. The computer-implemented method of claim 7, further comprising:
cancelling, by the at least one computer processor, the offer on the mobile device upon expiration of the countdown time limit.

9. The computer-implemented method of claim 1, further comprising:
receiving, by the at least one computer processor, a selection at the mobile device of a deregistration request; and
transmitting an alert to a Brand manager noting the deregistration to facilitate inviting re-registration.

10. The computer-implemented method of claim 1, wherein said receiving said selection of said registration request comprises:
receiving, collecting and transmitting to the server data comprising at least one of:
at least one brand selected;
at least one brand user identifier (ID);
at least one brand password;
a device identifier (ID);
a device type;
a username;
a date registered;
a location; or
a WI-FI service profile identifier (SPID).

11. The computer-implemented method of claim 2, wherein said receiving said at least one offer comprises:
receiving, collecting and storing data on the mobile device comprising:
at least one brand;
at least one offer identifier (ID);
an offer description;
an expiration date;
a value;
a username;
a send date; or
a predicted location.

12. The computer-implemented method of claim 2, further comprising:
receiving, collecting, and storing, by the at least one computer processor, at the server at least one of:
a brand;
an offer identifier (ID);
an offer description;
an expiration date;
a send date;
a value;
a device identifier (ID);
a username; or
a predicted location.

13. The computer-implemented method of claim 2, further comprising:
receiving, collecting, and storing, by the at least one computer processor, at the server at least one of:
a brand;
an offer identifier (ID);
a device identifier (ID);
a device type;
a username;
a date;
a location; or
a WI-FI service profile identifier (SPID).

14. The computer-implemented method of claim 2, further comprising:
synchronizing, by the at least one computer processor, offer data with the server comprising at least one of:
updating version of application program;
adding at least one new offer;
deleting at least one old offer; or
updating at least one message.

15. The computer-implemented method of claim 2, further comprising:
indicating relative expiration dates of a plurality of offers comprising at least one of:
indicating with a color whether an offer will expire soon;
indicating with a color whether an offer is new;
indicating with a color whether an offer is expired;
highlighting whether an offer will expire soon;
highlighting whether an offer is new; or
highlighting whether an offer is expired.

16. A system of providing promotions comprising:
at least one computer processing unit;
a network interface communicatively coupled to the at least one computer processing unit;
a memory communicatively coupled to the at least one computer processing unit, the memory containing instructions that when executed by the at least one computer processing unit configure the system to:
receive a selection of a registration request for at least one brand at a mobile device;
transmit said registration request to a server;
receive from the server an updated configuration file including confirmation of said registration request, at the mobile device.

17. A computer program product embodied on a computer accessible medium, the computer program product comprising program logic, which when executed on at least one computer processor provides a method of providing a promotion comprising:
receiving, by at least one computer processor, a selection of a registration request for at least one brand at a mobile device;
transmitting, by the at least one computer processor, said registration request to a server; and
receiving, by the at least one computer processor, from the server an updated configuration file including confirmation of said registration request, at the mobile device.
